(19) United States
(12) Patent Application Publication
(10) Pub. No.: US 2024/0336719 A1
(43) Pub. Date: Oct. 10, 2024

(54) Millable polyurethane rubber, preparation method and use thereof

(71) Applicant: Qingdao University of Science & Technology, Qingdao (CN)

(72) Inventors: Jinchun LIU, Qingdao (CN); Dongxu ZHAO, Qingdao (CN); Li LIU, Qingdao (CN); Xuemeng WANG, Qingdao (CN)

(21) Appl. No.: 18/461,953

(22) Filed: Sep. 6, 2023

(30) Foreign Application Priority Data
Apr. 4, 2023 (CN) 2023103523113

(51) Int. Cl. C08G 18/42; C08G 18/22; C08G 18/24; C08K 3/06; C08K 3/20

(52) U.S. Cl. CPC C08G 18/4238; C08G 18/222; C08G 18/227; C08G 18/246; C08K 3/06; C08K 3/20

(57) ABSTRACT

A millable polyurethane rubber, preparation method and use thereof. Raw materials thereof comprise the following ingredients in part by weight: polyester diol 100 parts; micromolecular diol 2-10 parts; diisocyanate 5-20 parts; antioxidant 0.1-0.5 part; catalyst 0.03-0.08 part; peroxide 1-1.5 parts and/or sulfur 1-1.5 parts. By structural design and formula adjustment, the millable polyurethane rubber has better low temperature resistance and gas permeability compared with conventional millable polyurethane rubbers, by using special micromolecular diol, synthesizing with polyester diol at a specific ratio and vulcanizing with peroxide or sulfur, molecular strands of the polyurethane have excellent smoothness and strong interaction forces, the millable polyurethane rubber has at the same time characteristics such as time good low temperature compression set, low gas permeability and high mechanical strength and can be used in manufacturing of films in scuba suspension systems.

### TECHNICAL FIELD

The present invention relates to the technical field of polymer materials, especially millable polyurethane rubber.

### BACKGROUND TECHNOLOGY

Polyurethane rubbers have been used in large amounts in more and more industrial applications, with regard to molecular structures, polyurethane consists of alternating soft segments (polyesters or polyether polyols) and hard segments (cross-linkers and diisocyanate), therefore, performance of polyurethane rubber can be adjusted in a large range. Especially, millable polyurethane rubbers vulcanized with polyester-type peroxides have very high mechanical strength, excellent oil-proof performance and hydraulic-oil proof performance, and in the meanwhile, can tolerate relatively high temperatures in engine compartments of automobiles. One of uses of polyurethane rubbers is as barrier films of hydropneumatic suspension systems, however, common millable polyurethane rubbers have limited low temperature tolerance and barrier abilities for gas permeation are not enough. Therefore, it is desirable to develop a kind of millable polyurethane rubber which has good low temperature resistance and low gas permeability.

### SUMMARY OF THE INVENTION

Based on the demands of the prior art, the purpose of the present invention is to address the problem that low temperature resistance performance of conventional millable polyurethane rubbers is poor while gas permeability thereof is high, and provides a millable polyurethane rubber with good low compression set and low gas permeability and vulcanized by peroxides or sulphur and the millable polyurethane rubber can be used in manufacturing of films in scuba suspension systems.

To realize the foregoing purpose, the present invention provides the following technical solutions:

A first aspect of the present invention provides a millable polyurethane rubber with good low temperature resistance and good gas permeability, and raw materials thereof comprise the following ingredients in part by weight:
polyester-diol 100 parts by weight;
micromolecular diol 2-10 parts by weight;
diisocyanate 5-20 parts by weight;
antioxidant 0.1-0.5 part by weight;
catalyst 0.03-0.08 part by weight;
peroxide 1-1.5 parts by weight;
and/or sulphur 1-1.5 parts by weight.

A second aspect of the present invention provides a preparation method of millable polyurethane rubber of good low temperature resistance and low gas permeability, comprising the following steps:
dehydrating the polyester-diol 100 parts by weight and micromolecular diol 2-10 parts by weight at 100-120° C. for 1 h, cooling down until 60-80° C., adding diisocyanate 5-20 parts by weight, antioxidant 0.1-0.5 parts by weight and catalyst 0.03-0.08 part by weight, mixing and stirring for 1 min at 80° C., pouring into a mold to cure for 2-3 h, demolding, adding peroxide 1-1.5 parts by weight or sulphur 1-1.5 parts by weight or adding both the peroxide 1-1.5 parts by weight and sulphur 1-1.5 parts by weight to crude rubber 100 parts by weight, milling evenly, vulcanizing for 6-10 min at 160-170° C. and obtaining the millable polyurethane rubber.

A third aspect of the present invention provides uses of the millable polyurethane rubber of good low temperature resistance and gas permeability and vulcanized by peroxide or sulphur.

Beneficial effects of the present invention comprise at least:

Principles of the present invention are: in the present invention, by structural design and formula adjustment, the millable polyurethane rubber has better low temperature resistance and gas permeability compared with conventional millable polyurethane rubber, by using special micromolecular diol, synthesizing with polyester diol as per a specific ratio and vulcanizing with peroxide or sulfur, molecular strands of the polyurethane have excellent smoothness and strong interaction forces, the millable polyurethane rubber provided in the present invention has at the same time characteristics such as time good low temperature compression set, low gas permeability and high mechanical strength and can be used in manufacturing of films in scuba suspension systems.

The low-temperature permanent deformation of the millable polyurethane rubber according to the present invention can be as low as 12%, the gas permeability coefficient thereof can be as low as less than 6.5×10⁻⁸ cm²·sec⁻¹·atm⁻¹, the millable polyurethane rubber has very excellent low temperature compression set, low gas permeability and high mechanical strength, therefore, the present invention can be widely used in circumstances with high gas tightness requirements and low temperature usage conditions (for example, temperatures under 10° C.), and can especially be used in manufacturing of films of scuba suspension systems.

Attention shall be paid to the fact that, the uses of the millable polyurethane rubber are not subjected to limitations in the foregoing background technology or other portions, the uses mentioned in the background technology or other portions are only common use conditions and the present invention is not limited to these conditions, and the millable polyurethane rubber can be used in conditions where high requirements are placed on gas tightness and low temperature conditions (such as lower than 10° C.).

The characteristics and advantages of the present invention will be explained in detail in the subsequent embodiments.

### EMBODIMENTS

To make the purpose, technical solutions and advantageous effects of the present invention more clear, hereinafter with reference to the embodiments and examples a further description will be given to the present invention. It shall be appreciated that, the embodiments given here are merely exemplary explanation of the embodiments of the present invention and intended to explain the present invention and do not form any limitation to the present invention.

The endpoints of a range and any value disclosed in the present invention shall not be limited to the exact range or value, and the range or value shall be understood to comprise values close to the range or value, and the values close to the range or value are values falling into a range of +10% of specific values. For numerical ranges, combination among endpoints of the ranges, among endpoints of the ranges and individual values and among individual values can result in one or more new numerical ranges, and the new numerical ranges shall be construed to have been disclosed in the present invention. In the description of the present invention, unless otherwisely explained, terms such as “one or a/an”, “more or a plurality of” mean two or more.

The purpose of the present invention is realized by providing the following technical solutions: a first aspect of the present invention provides a millable polyurethane rubber with good low temperature resistance and gas tightness and vulcanized by peroxides or sulfur, wherein raw materials of the millable polyurethane rubber comprises the following ingredients calculated at part by weight:
Polyester diol 100 parts by weight;
Micromolecular diol 2-10 parts by weight;
Diisocyanate 5-20 parts by weight;
Antioxidant 0.1-0.5 part by weight;
Catalyst 0.03-0.08 part by weight;
Peroxide 1-1.5 parts by weight and/or sulfur 1-1.5 parts by weight.

According to the present invention, for the millable polyurethane rubber to have better low temperature resistance and gas tightness, the polyester diol has a molecular weight in a range of 1500-7000. Preferably, the polyester diol comprises poly(propylene adipate). For the millabe polyurethane rubber to further have better low temperature resistance and gas tightness, more preferably, the polyester diol comprises polycondensation products of hexane diacid, 2-methyl-1,3-propanediol and/or 1,4-cyclohexanedimethanol or 1,3-propanediol. Further preferably, in the ingredients of the polyester diol, a mole percent ratio of the 2-methyl-1,3-propanediol, 1,4-cyclohexanedimethanol or 1,3-propanediol ranges from 1:4 to 4:1.

According to the present invention, to provide the millable polyurethane rubber with better low temperature resistance and gas tightness, a molecular weight of the micromolecular diol is 60-200. Preferably, the micromolecular diol comprises at least one of ethylene glycol, 1,4-butanediol, 1,6-hexamethylene glycol, allylin and trimethylolpropane monoallyl ether. Further preferably, the micromolecular diol comprises allylin and trimethylolpropane monoallyl ether.

According to the present invention, to provide the millable polyurethane rubber with better low temperature resistance and gas tightness, the diisocyanate comprises at least one of toluene di-isocyanate, methyl diphenylene diisocyanate, 4,4′-diisocyanato dicyclohexylmethane and hexamethylene diisocyanate, wherein methyl diphenylene diisocyanate comprises MDI-100 and MDI-50 depending on contents of 4,4′-MDI. Preferably, the diisocyanate comprises at least one of TDI, MIDI-50 and HMDI.

According to the present invention, main functions of antioxidant are to inhibit degradation of the polyurethane molecular strands under action of thermal oxidation and extend usage life of the materials. The antioxidant comprises at least one of Tetrakis[β-(3,5-di-tert-butyl-4-hydroxyphenyl)propionic acid] pentaerythritol ester (antioxidant 1010) and triethylene bis glycol β-(3-tert-butyl-4-hydroxy-5-methylphenyl) propionate (antioxidant 245).

According to the present invention, main functions of the catalyst are to accelerate gel reaction and reduce polymerization time. The catalyst comprises at least one of dibutyl tin laurate, stannous octoate, phenylmercuric acetate (PMA), lead bis(2-ethylhexanoate), organic zinc and organobismuth. More preferably, the catalyst comprises at least one of dibutyl tin laurate, organic zinc and organobismuth.

According to the present invention, to provide the millable polyurethane rubber with better low temperature resistance and gas tightness, the millable polyurethane rubber can be vulcanized jointly by peroxides and/or sulfur. Preferably, calculated at mass fraction, a mass fraction of the peroxides is 1-1.5; a mass fraction of the sulfur is 1-1.5; and when vulcanizing with both the peroxides and sulfur, the mass fraction of both the peroxide and the sulfur is 1.

A second aspect of the present invention provides a preparation method of the millable polyurethane rubber with good low temperature resistance and gas tightness and vulcanized by peroxide or sulfur, wherein the preparation method comprises the following steps:
Dehydrating the polyester diol 100 parts by weight and micromolecular diol 2-10 parts by weight at 100-120° C. for 1 h, cooling down until 60-80° C., adding diisocyanate 5-20 parts by weight, antioxidant 0.1-0.5 parts by weight and catalyst 0.03-0.08 parts by weight, mixing and stirring quickly for 1 min at 80° C., pouring into a mold for curing for 2-3 h at 100° C., demolding and obtaining a crude rubber, adding peroxides 1-1.5 parts by weight or sulfur 1-1.5 parts by weight or both peroxides 1 part by weight and sulfur 1 part by weight into the crude rubber 100 parts by weight, milling evenly, vulcanizing for 6-10 min at 160-170° C. and obtaining the millable polyurethane rubber.

Further, the polyester diol is obtainable by:
Mixing hexane diacid 50 mol % with 2-methyl-1,3-propanediol 10-40 mol % and 1,4-cyclohexanedimethanol 10-40 mol % or 1,3-propanediol 10-40 mol %, polycondensating for 1-2 h at 180-220° C., dehydrating for 1 h, cooling down until 60-80° C. and obtaining the polyester diol.

During preparation of the millable polyurethane rubber, the raw materials can further comprise antiozonant and/or ultraviolet absorbent as auxiliaries.

Preferably, to provide the millable polyurethane rubber with better mechanical strength, a reinforcing agent used in the present invention can be carbon black.

A vulcanizing activator can contribute to vulcanization and cross linking of rubber. Preferably, to provide desired degree of cross linking and vulcanizetion efficiency, the vulcanizing activator in the present invention can be stearic acid.

Further, during preparation of the millable polyurethane rubber, the antiozonant and/or the ultraviolet absorbent can be added during synthesis of the crude rubber.

The reinforcing agent and the vulcanizing activator can be added during milling and processing of the rubber.

It shall be noted that, the present invention can further comprises other auxiliaries, to the extent that the auxiliaries do not run against the goal to furnish the millable polyurethane rubber with good low-temperature compression set, low gas permeability and high mechanical strength.

A use of the millable polyurethane rubber with good low temperature resistance and gas permeability and vulcanized by peroxides or sulfur, wherein the millable polyurethane rubber can be used in manufacturing of films of scuba suspension systems.

Hereinafter a detailed description will be given based on specific embodiments.

Raw materials used in the following embodiments are:
hexane diacid (bought from Xuchuan Chemical Co., Ltd.)
2-methyl-1,3-propanediol (bought from Xuchuan Chemical Co., Ltd.)
1,4-cyclohexanedimethanol (bought from Xuchuan Chemical Co., Ltd.)
1,3-propanediol (bought from Xuchuan Chemical Co., Ltd.)
ethylene glycol (bought from Xuchuan Chemical Co., Ltd.)
1,4-butanediol (bought from Xuchuan Chemical Co., Ltd.)
allylin (bought from Shanghai Nuotai Chemical Co., Ltd.)
trimethylolpropane monoallyl ether (bought from Shanghai Nuotai Chemical Co., Ltd.)
methyl diphenylene diisocyanate (bought from Wanhua Chemical Group Co., Ltd.)
dibutyl tin laurate (bought from Beijing Chemical Industry 3rd factory)
cumyl peroxide (bought from Qingdao Jinge Rubber Auxiliaries Co., Ltd.)
sulfur (bought from Qingdao Jinge Rubber Auxiliaries Co., Ltd.)
N990 (a kind of carbon block, as a reinforcing agent, bought from Shanghai Cabot Corporation)
stearic acid (as vulcanizing activator, bough from Qingdao Jinge Rubber Auxiliaries Co., Ltd.)

### Embodiment 1: Preparation of the Millable Polyurethane Rubber

1) Synthesis and preparation of polyester diol: mixing hexane diacid 50 mol % with 2-methyl-1,3-propanediol 30 mol % and 1,4-cyclohexanedimethanol 20 mol % in a dry flask, maintaining the reaction temperature to be 180-220° C., polycondensating for 2 h at 180-220° C., dehydrating at vacuum conditions of −0.1 MPa for 1 h, cooling down until 60-80° C. and obtaining the polyester diol with a molecular weight of 3500.
2) Dehydrating the polyester diol 100 parts by weight and allylin 2 parts by weight at 100-120° C. for 1 h, cooling down until 60-80° C., adding methyl diphenylene diisocyanate 10 parts by weight, antioxidant 1010 0.5 part by weight and dibutyl tin laurate 0.05 part by weight, mixing quickly at 80° C. for 1 min, pouring into a mold and curing for 2-3 h at 100° C., demolding and obtaining the crude rubber.
3) Adding cumyl peroxide 1.5 parts by weight or sulfur 1.5 parts by weight or both the cumyl peroxide 1 part by weight and sulfur 1 part by weight into the crude rubber, adding stearic acid 0.5 part by weight and N990 20 parts by weight, milling evenly, vulcanizing for 10 min at 170° C. and obtaining the millable polyurethane rubber.

### Embodiment 2: Preparation of the Millable Polyurethane Rubber

1) Synthesis and preparation of polyester diol: mixing hexane diacid 50 mol % and 2-methyl-1,3-propanediol 20 mol % and 1,3-propanediol 30 mol % in a dry flask, maintaining the temperature to be 180-220° C., conducting polycondensation reaction for 2 h at 180-220° C., dehydrating in vacuum conditions for 1 h at −0.1 MPa, cooling down until 60-80° C. and obtaining the polyester diol with a molecular weight of 3500.
2) Dehydrating the polyester diol 100 parts by weight and allylin 2 parts by weight at 100-120° C. for 1 h, cooling down until 60-80° C., adding methyl diphenylene diisocyanate 10 parts by weight, antioxidant 1010 0.5 part by weight and dibutyl tin laurate 0.05 part by weight, mixing and stirring quickly for 1 min at 80° C., pouring into a mold and curing for 2-3 h at 100° C., demolding and obtaining the crude rubber.
3) Adding cumyl peroxide 1.5 parts by weight or sulfur 1.5 parts by weight or both the cumyl peroxide 1 part by weight and sulfur 1 part by weight into the crude rubber, adding stearic acid 0.5 part by weight and N990 20 parts by weight, milling evenly, vulcanizing for 10 min at 170° C. and obtaining the millable polyurethane rubber.

### Embodiment 3: Preparation of the Millable Polyurethane Rubber

1) Synthesis and preparation of polyester diol: mixing hexane diacid 50 mol % and ethylene glycol 35 mol % and 1,3-propanediol 15 mol % in a dry flask, maintaining the temperature to be 180-220° C., conducting polycondensation reaction for 2 h at 180-220° C., dehydrating in vacuum conditions for 1 h at −0.1 MPa, cooling down until 60-80° C. and obtaining the polyester diol with a molecular weight of 2000.
2) Dehydrating the polyester diol 100 parts by weight and allylin 2 parts by weight at 100-120° C. for 1 h, cooling down until 60-80° C., adding methyl diphenylene diisocyanate 10 parts by weight, antioxidant 1010 0.5 part by weight and dibutyl tin laurate 0.05 part by weight, mixing and stirring quickly for 1 min at 80° C., pouring into a mold and curing for 2-3 h at 100° C., demolding and obtaining the crude rubber.
3) Adding cumyl peroxide 1.5 parts by weight or sulfur 1.5 parts by weight or both the cumyl peroxide 1 part by weight and sulfur 1 part by weight into the crude rubber, adding stearic acid 0.5 part by weight and N990 20 parts by weight, milling evenly, vulcanizing for 10 min at 170° C. and obtaining the millable polyurethane rubber.

### Embodiment 4: Preparation of the Millable Polyurethane Rubber

1) Synthesis and preparation of polyester diol: mixing hexane diacid 50 mol % and ethylene glycol 30 mol % and 1,4-butanediol 20 mol % in a dry flask, maintaining the temperature to be 180-220° C., conducting polycondensation reaction for 2 h at 180-220° C., dehydrating in vacuum conditions for 1 h at −0.1 MPa, cooling down until 60-80° C. and obtaining the polyester diol with a molecular weight of 2800.
2) Dehydrating the polyester diol 100 parts by weight and allylin 2 parts by weight at 100-120° C. for 1 h, cooling down until 60-80° C., adding methyl diphenylene diisocyanate 10 parts by weight, antioxidant 1010 0.5 part by weight and dibutyl tin laurate 0.05 part by weight, mixing and stirring quickly for 1 min at 80° C., pouring into a mold and curing for 2-3 h at 100° C., demolding and obtaining the crude rubber.
3) Adding cumyl peroxide 1.5 parts by weight or sulfur 1.5 parts by weight or both the cumyl peroxide 1 part by weight and sulfur 1 part by weight into the crude rubber, adding stearic acid 0.5 part by weight and N990 20 parts by weight, milling evenly, vulcanizing for 10 min at 170° C. and obtaining the millable polyurethane rubber.

### Embodiment 5: Preparation of the Millable Polyurethane Rubber

1) Synthesis and preparation of polyester diol: mixing hexane diacid 50 mol % and 2-methyl-1,3-propanediol 30 mol % and 1,4-butanediol 20 mol % in a dry flask, maintaining the temperature to be 180-220° C., conducting polycondensation reaction for 2 h at 180-220° C., dehydrating in vacuum conditions for 1 h at −0.1 MPa, cooling down until 60-80° C. and obtaining the polyester diol with a molecular weight of 4000.
2) Dehydrating the polyester diol 100 parts by weight and allylin 2 parts by weight at 100-120° C. for 1 h, cooling down until 60-80° C., adding methyl diphenylene diisocyanate 10 parts by weight, antioxidant 1010 0.5 part by weight and dibutyl tin laurate 0.05 part by weight, mixing and stirring quickly for 1 min at 80° C., pouring into a mold and curing for 2-3 h at 100° C., demolding and obtaining the crude rubber.
3) Adding cumyl peroxide 1.5 parts by weight or sulfur 1.5 parts by weight or both the cumyl peroxide 1 part by weight and sulfur 1 part by weight into the crude rubber, adding stearic acid 0.5 part by weight and N990 20 parts by weight, milling evenly, vulcanizing for 10 min at 170° C. and obtaining the millable polyurethane rubber.

### Embodiment 6: Performance Test of the Millable Polyurethane Rubber

Performance test of the millable polyurethane rubber obtained in embodiments 1-5 were conducted in the following manner and the results are shown in table 1.

### Low-Temperature Compression Set:

Low-temperature compression set test was conducted as per GB/T 7759:

### Gas Permeability Coefficient:

Gas permeability coefficient test was done as per ASTM D1434-82.

TABLE 1
performance indicators of the millable polyurethane rubbers

| | | | | Gas permeability |
|---|---|---|---|---|
| | Low-temperature compression set/% | | | coefficient/cm² · |
| | −10° C. | −20° C. | −30° C. | sec⁻¹ · atm⁻¹ |
| Embodiment 1 | 21% | 31% | 53% | 4.8 × 10⁻⁸ |
| Embodiment 2 | 19% | 29% | 51% | 4.7 × 10⁻⁸ |
| Embodiment 3 | 27% | 40% | 69% | 5.8 × 10⁻⁸ |
| Embodiment 4 | 12% | 22% | 31% | 7.5 × 10⁻⁸ |
| Embodiment 5 | 15% | 23% | 29% | 11.5 × 10⁻⁸ |

As can be seen from table 1, comparing embodiment 1 with embodiment 2, in the case that the chain extenders and the isocayanate used are the same, the millable polyurethane rubber prepared from polyester diol synthesized from 1,3-propanediol has lower low-temperature compression set; comparing embodiment 1 with embodiment 5, in the case that the chain extenders and the isocayanate used are the same, the millable polyurethane rubber prepared from polyester diol synthesized from 1,4-butanediol has lower gas permeability coefficient and lower low-temperature compression set; comparing embodiment 3 with embodiment 4, in the case that the chain extenders and the isocayanate used are the same, the millable polyurethane rubber prepared from polyester diol of a higher molecular weight has lower gas permeability coefficient and lower low-temperature compression set.

Compare with the prior art, the millable polyurethane rubber prepared according to the present invention has a low-temperature compression set as low as 12%, gas permeability coefficient 6.5×10⁻⁸, and is characterized by good low-temperature compression set, low gas permeability and high mechanical strength, therefore, the millable polyurethane rubber can be used in conditions where high requirements are placed on gas tightness and low temperature conditions (such as lower than 10° C.) and can be used in especially manufacturing of films of scuba suspension systems.

Finally it shall be noted that, the foregoing embodiments are intended to explain the technical solutions of the present invention and shall not be construed as limitations on the present invention. Within the technical spirit of the present invention, it is still possible to make a plurality of simple changes to the technical solutions of the present invention, and the technical features can be combined in any other appropriate manners, and the simple changes and combinations shall be considered to have been disclosed in the present invention and fall into the protection scope of the present invention.

1. A millable polyurethane rubber with good low temperature resistance and gas tightness and vulcanized by peroxides or sulfur, wherein raw materials of the millable polyurethane rubber comprises the following ingredients calculated at part by weight:
polyester diol 100 parts by weight;
micromolecular diol 2-10 parts by weight;
diisocyanate 5-20 parts by weight;
antioxidant 0.1-0.5 part by weight;
catalyst 0.03-0.08 part by weight;
peroxide 1-1.5 parts by weight and/or sulfur 1-1.5 parts by weight.

2. The millable polyurethane rubber according to claim 1, wherein, the polyester diol has a molecular weight in a range of 1500-7000.

3. The millable polyurethane rubber according to claim 2, wherein, the polyester diol comprises polycondensation products of hexane diacid, 2-methyl-1,3-propanediol and/or 1,4-cyclohexanedimethanol or 1,3-propanediol.

4. The millable polyurethane rubber according to claim 3, wherein, in ingredients of the polyester diol, a mole percent ratio of the 2-methyl-1,3-propanediol, 1,4-cyclohexanedimethanol or 1,3-propanediol ranges from 1:4 to 4:1.

5. The millable polyurethane rubber according to claim 1, wherein, a molecular weight of the micromolecular diol is 60-200.

6. The millable polyurethane rubber according to claim 5, wherein, the micromolecular diol comprises at least one of ethylene glycol, 1,4-butanediol, 1,6-hexamethylene glycol, allylin and trimethylolpropane monoallyl ether.

7. The millable polyurethane rubber according to claim 1, wherein, the diisocyanate comprises at least one of toluene di-isocyanate, methyl diphenylene diisocyanate, 4,4′-diisocyanato dicyclohexylmethane and hexamethylene diisocyanate.

8. The millable polyurethane rubber according to claim 7, wherein, the diisocyanate comprises at least one of TDI, MDI-50 and HMDI.

9. The millable polyurethane rubber according to claim 1, wherein, the catalyst comprises at least one of dibutyl tin laurate, stannous octoate, phenylmercuric acetate (PMA), lead bis(2-ethylhexanoate), organic zinc and organobismuth.

10. The millable polyurethane rubber according to claim 9, wherein, the catalyst comprises at least one of dibutyl tin laurate, organic zinc and organobismuth.

11. The millable polyurethane rubber according to claim 1, wherein, the millable polyurethane rubber is vulcanizeable by peroxides and/or sulfur.

12. The millable polyurethane rubber according to claim 11, wherein, calculated at mass fraction, a mass fraction of the peroxide is 1-1.5.

13. The millable polyurethane rubber according to claim 11, wherein, calculated at mass fraction, a mass fraction of the sulfur is 1-1.5.

14. The millable polyurethane rubber according to claim 11, wherein, calculated at mass fraction, when vulcanizing with both the peroxide and sulfur, the mass fraction of both the peroxide and the sulfur is 1.

15. The millable polyurethane rubber according to claim 1, wherein the raw materials further comprise auxiliaries, and the auxiliaries comprise antiozonant and/or ultraviolet absorbent.

16. A preparation method of the millable polyurethane rubber as defined in claim 15, wherein the preparation method comprises the following steps:
dehydrating the polyester diol 100 parts by weight and micromolecular diol 2-10 parts by weight at 100-120° C. for 1 h, cooling down until 60-80° C., adding diisocyanate 5-20 parts by weight, antioxidant 0.1-0.5 parts by weight and catalyst 0.03-0.08 parts by weight, mixing and stirring quickly for 1 min at 80° C., pouring into a mold for curing for 2-3 h at 100° C., demolding and obtaining a crude rubber, adding peroxides 1-1.5 parts by weight or sulfur 1-1.5 parts by weight or both peroxides 1 part by weight and sulfur 1 part by weight into the crude rubber 100 parts by weight, milling evenly, vulcanizing for 6-10 min at 160-170° C. and obtaining the millable polyurethane rubber.

17. The preparation method of the millable polyurethane rubber according to claim 16, wherein the polyester diol is obtainable by:
mixing hexane diacid 50 mol % with 2-methyl-1,3-propanediol 10-40 mol % and 1,4-cyclohexanedimethanol 10-40 mol % or 1,3-propanediol 10-40 mol %, polycondensating for 1-2 h at 180-220° C., dehydrating for 1 h, cooling down until 60-80° C. and obtaining the polyester diol.

18. A use of the millable polyurethane rubber as defined in claim 1, wherein the millable polyurethane rubber is used in manufacturing of films of scuba suspension systems.
